(19) United States
(12) Patent Application Publication
(10) Pub. No.: US 2015/0109603 A1
(43) Pub. Date: Apr. 23, 2015

(54) MULTI-WAVELENGTH IMAGE LIDAR SENSOR APPARATUS AND SIGNAL PROCESSING METHOD THEREOF

(71) Applicant: Electronics and Telecommunications Research Institute, Daejeon (KR)

(72) Inventors: Jong Deog KIM, Daejeon (KR); Kee Koo KWON, Daegu (KR); Soo In LEE, Daejeon (KR)

(73) Assignee: Electronics and Telecommunications Research Institute, Daejeon (KR)

(21) Appl. No.: 14/223,171

(22) Filed: Mar. 24, 2014

(30) Foreign Application Priority Data
Oct. 21, 2013 (KR) 10-2013-0125375

(51) Int. Cl. G01S 17/10

(52) U.S. Cl. CPC G01S 17/10
USPC 356/4.07

(57) ABSTRACT

Disclosed are a next-generation lidar sensor apparatus that may acquire and process individual characteristic information about an object in addition to distance and shape information about the object, and a signal processing method thereof. According to the present invention, it is possible to accurately and quickly identify and track the object by adding a function of measuring unique material characteristics, such as a color and reflectance of the object, to the three-dimension image lidar sensor for measuring a position and speed of the object. In addition, when a plurality of lidar sensors are distributed on a space where measurable distances partially overlap with each other, it is possible to remove interference and naturally occurring noise between adjacent lidar sensor signals.

### CROSS-REFERENCE TO RELATED APPLICATIONS

This application claims priority to and the benefit of Korean Patent Application No. 10-2013-0125375, filed on Oct. 21, 2013 the disclosure of which is incorporated herein by reference in its entirety.

### TECHNICAL FIELD

The present invention relates to a lidar sensor apparatus for detecting a distance to and a shape of an object based on laser or light, and a signal processing method thereof, and more particularly, to a next-generation lidar sensor apparatus for acquiring and processing information about an individual characteristic of an object in addition to information about a distance to and a shape of the object, and a signal processing method thereof.

### BACKGROUND

Efforts are being made to develop an intelligent device and service by detecting in real time a shape and position of an object that is distributed on a space. Among a variety of sensors for this, a camera vision can detect a 2-D image and color information with high resolution, and a stereoscopic camera can create a 3-D image by adding position information for an object that is relatively close. A radar sensor using an RF signal can provide information about a position and speed of an object that are at a remote position and above a detectable size. Similarly, a laser scanner or lidar sensor using light can provide information about a shape of an object in addition to information about a position and speed of the object.

The camera vision may basically have a simple configuration including a detector for receiving natural visible light, but may need relatively high output illumination, such as headlight or flashlight, where light quantity is not enough, for example, at night time or in a tunnel.

The lidar sensor may emit a laser beam in a visible light range or infrared ray range and detect a signal received from an object to acquire information in the same method, irrespective of change in surrounding environment. However, in order to obtain information about an image with a camera level resolution, a complicated system configuration and high cost are expected.

In this specification, the term “lidar sensor” refers to both a sensor using a non-coherence light source, such as a white light source and an LED, and a sensor using a coherence light source, such as a laser. In particular, a sensor using a laser light source is referred to as a laser sensor.

A laser sensor recently developed to acquire a 3-D image is largely classified into a laser scanner and a flash laser lidar. The laser scanner can rotationally or linearly scan a space, using one or more laser pointer beams, and collect 3-D image information at tens of frames per second. Representative products of the laser scanner include HDL-64E and HDL-32E of Velodyne Inc., which have 64 or 32 laser light sources and receivers corresponding to the laser light sources. Similarly, LD-MRS of SICK, Inc. and LUX 8L of IBEO, Inc. are laser scanner products that can secure a vertical viewing angle within 10 degrees using 4 or 8 laser light sources to acquire a 3-D image, though restrictively.

The flash lidar spreads and emits a laser beam over a space, similarly to the flash light, and acquires image information for each pixel through unit cells of an array receiving device from the received reflected light, similarly to a camera CMOS image sensor. A representative example is a 3D Flash Lidar product of ASC, Inc., which includes a flash transmitting unit including a laser light source with a wavelength of 1550 nm for eye-safety and a receiving unit including a 128×128 InGaAs APD array.

The laser sensors described above cannot collect color information when acquiring shape information of an object because the laser sensors use one single laser, or use various wavelengths of lasers only as means for securing different viewing angles. Accordingly, the laser sensors may visually discern an object by acquiring image information from monochromatic dots, classifying objects through signal processing based on position and shape information of a set of neighboring dots, and randomly allocate general colors to the objects.

However, if it is possible to acquire image information including color information and perform signal processing on the image information, it may be more clear and easy than a case of using a monochromatic color to perform classification and tracking.

As a related art for measuring a specific material distributed in the atmosphere, differential absorption lidar (DIAL) is to observe existence and concentration of a specific gas according to the relative difference in absorptance, using lasers having two wavelengths which have different absorptances into an observation target. In U.S. Pat. No. 5,157,257, Allen R. Geiger, et al. have proposed a system configuration and method for performing time or wavelength multiplexing on laser beams having six IR wavelengths for “Mid-infrared light hydrocarbon DIAL Lidar.”

As a related art laser sensor technology for further measuring color information in addition to a 3-D image, in U.S. 2010/0302528 A1, David S. Hall has provided a color laser scanner that acquires distance information using one infrared ray (IR) laser and one IR receiver corresponding to this and acquires color information using three lasers having visible light region wavelengths of red, green, and blue (RGB) and respective RGB receivers corresponding to this. When 3-D image information with high resolution is acquired in addition to RGB color information through such a method, an effect of integrating a visible light region camera function into a single lidar sensor can be expected.

However, since four lasers having different wavelengths may be configured to assembled in close proximity to each other and directed to the same point, there is a high possibility that an error of observing more or less different observation point will occur though the lasers are precisely aligned such that the direction points of the lasers are the same. In addition, in order to configure 64 channels, as in HDL-64E, for vertical axis image information, the same number of receivers will be required as the number (64×4=256) of lasers.

In particular, a coherence laser point light source in a visible light region may cause significant harm to the eye, compared to a white light having the same intensity, and thus need the consideration of eye-safety. To this end, wavelength selection is important in addition to the output control of the laser. For example, a long wavelength IR region, such as 1550 nm, advantageously may have higher absorptance by water in cornea and lens than a visible light region, thereby avoiding damage of optic nerves on the retina, and also utilize an InGaAs light-receiving element having good photoelectric conversion characteristics.

Accordingly, as in U.S. Patent No. 2010/0302528 A1, a lidar sensor having 32 or 64 channels in a vertical direction, where each channel has three visible light lasers for RGB wavelengths, is expected to have limitations between an output power intensity and a measurable distance to secure the safety of eyes.

### SUMMARY

Accordingly, the present invention provides an advanced multi-wavelength image lidar sensor apparatus having an enhanced object identification ability by additionally detecting an unique characteristic, such as a color or reflectance of an measurement object, and a signal processing method thereof.

The present invention also provides an advanced multi-wavelength image lidar sensor apparatus having a reduced error, and a signal processing method thereof when a plurality of lidar sensors using the same wavelength are distributed on a space where measurable distances thereof overlap with each other and thus there is high possibility to generate virtual image or noise information due to interference between adjacent sensor signals.

The object of the present invention is not limited to the aforesaid, but other objects not described herein will be clearly understood by those skilled in the art from descriptions below.

In one general aspect, a multi-wavelength image lidar sensor apparatus includes: a transmitting unit configured to output a multi-wavelength optical pulse signal; an optical transceiving unit configured to convert the multi-wavelength optical pulse signal into a transmission optical signal, output the transmission optical signal to a space, and transmit a reception optical signal generated by collecting signals, the signals being obtained by reflecting the transmission optical signal on the object of the space; a receiving unit configured to measure reflection signal intensities of respective wavelengths in the reception optical signal; and a processor configured to calculate chromatic coordinate information about the reception optical signal, the chromatic coordinate information varying depending on the reflection signal intensities of respective wavelengths.

The processor may calculate ratios between the reflection signal intensities of respective wavelengths and use the ratios as the chromatic coordinate information.

The processor may compare the chromatic coordinate information with a material database classified into hierarchical classes according to the ratios between the reflection signal intensities of respective wavelengths to provide probabilistic information about materials that are matched to the chromatic coordinate information.

The processor may form a three-dimension image frame of the measurement space, using the chromatic coordinate information and three-dimension position coordinate information about measurement points, three-dimension position coordinate information being determined by the time taken by the reception optical signal to be reflected and returned from a measurement point of each of objects positioned on the measurement space.

The transmission optical signal may include a first wavelength optical pulse signal with any wavelength, a second wavelength optical pulse signal with a predefined time interval from the first wavelength optical pulse signal, and a third wavelength optical signal with a predefined time interval from the second wavelength optical pulse signal.

At least one of single-wavelength optical pulse signals having various wavelengths and constituting the transmission optical signal may be generated in a dual pulse form with a predefined time interval.

The receiving unit may compare a time interval of optical pulse signals detected for each wavelength in the reception optical signal with a time interval predefined in the transmission optical signal and check whether the reception optical signal is received within a tolerable error range to evaluate reliability of the reception optical signal.

The receiving unit may check whether any one single-wavelength optical pulse signal in the reception optical signal has a dual pulse form having a predefined interval to evaluate reliability of the reception optical signal.

The transmitting unit may include light sources configured to output optical pulse signals having a certain time interval and different wavelengths and filters configured to multiplexedly integrate the optical pulse signals into a single optical waveguide and output the optical pulse signals as a multi-wavelength transmission optical pulse signal.

The optical transceiving unit may include a transmitting-side collimator configured to convert a multi-wavelength transmission optical pulse signal into a semi-pointer balance integration optical signal; an optical divider configured to transmit a portion of the semi-pointer balance integration optical signal and reflect another portion thereof; a beam scanner configured to pointer-scan a portion of an optical signal divided by the optical divider, on a space; a reflection mirror configured to totally reflect another portion of the optical signal divided by the optical divider; and a receiving-side collimator configured to collect signals obtained by reflecting an optical signal on one point of an object, the optical signal being pointer-scanned on a space, and deliver the signals to the receiving unit.

Other features and aspects will be apparent from the following detailed description, the drawings, and the claims.

### BRIEF DESCRIPTION OF THE DRAWINGS

FIG. 1 is a block diagram showing a configuration of a three-wavelength image scanning lidar sensor apparatus according to an embodiment of the present invention.

FIG. 2 is a block diagram showing a configuration of a three-wavelength image scanning lidar sensor apparatus according to another embodiment of the present invention.

FIG. 3 illustrates a time relation between a transmission pulse signal and a reception pulse signal.

FIG. 4 illustrates an example of different measurement points in objects on a space.

FIG. 5 illustrates an example of reflectance according to the measurement positions and wavelengths of FIG. 4.

FIG. 6 is a flowchart showing an example of a signal processing method utilizing a sensor signal measured according to another aspect of the present invention.

FIG. 7 illustrates an example of material classification according to mutual ratios between reflectances of respective wavelengths.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

The present invention provide a signal processing method for indentifying and tracking an object by using, as a basic measuring unit, lidar sensor signals including a plurality of different wavelength to extract different features of objects on a space in addition to a 3-D image. As an embodiment of the description, a method for configuring a three-wavelength lidar sensor has been proposed. The characteristics of the method are different from those of a color laser scanner proposed in U.S. 2010/0302528 A1, but similar to DIAL technologies using two or more wavelengths, which have developed to measure material characteristics in the atmosphere.

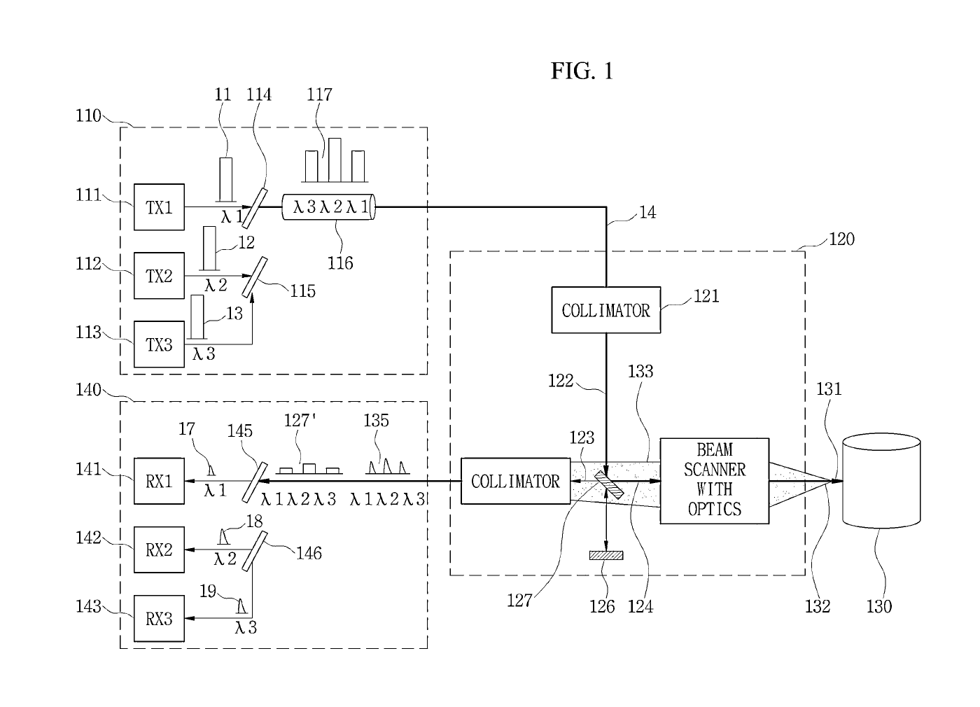

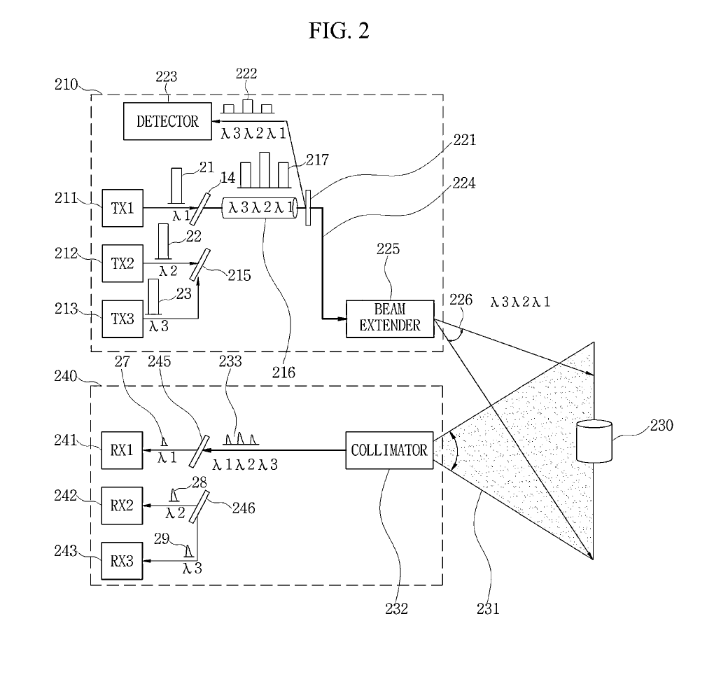

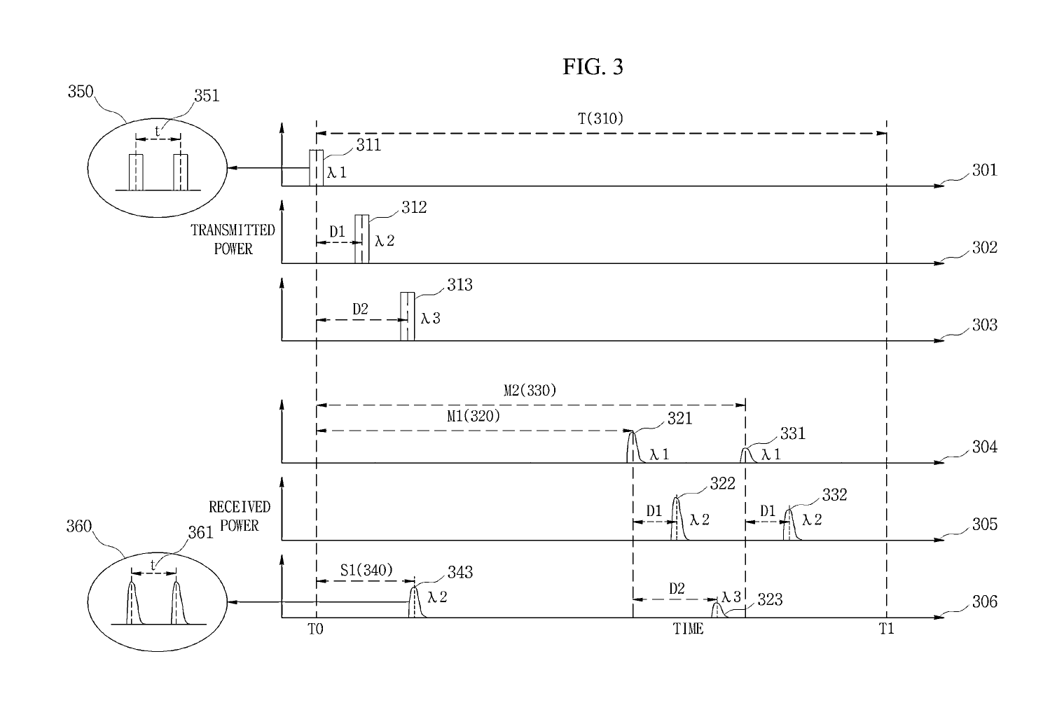

Accordingly, an embodiment of a three-wavelength lidar sensor apparatus will be described with reference to FIGS. 1 and 2, focusing on some different elements in comparison with a configuration of a typical multi-wavelength lidar sensor apparatus. A signal processing method of the three-wavelength lidar sensor apparatus will be described with reference to FIGS. 3 to 7.

FIG. 1 is a block diagram showing a configuration of a three-wavelength image scanning lidar sensor apparatus according to an embodiment of the present invention.

Referring to FIG. 1, the three-wavelength image scanning lidar sensor apparatus according to an embodiment of the present invention includes a transmitting unit 110, an optical transceiving unit 120, and a receiving unit 140.

The transmitting unit 110 includes three-wavelength light sources 111, 112, and 113 and WDM filters 114 and 115 for multiplexedly integrating optical pulse signals 11, 12, and 13 having wavelengths of λ1, λ2, and λ3 output therefrom into a single optical waveguide 116. The multiplexedly integrated three-wavelength light pulse signals 117 are output at a time interval.

The optical transceiving unit 120 includes a transmitting-side collimator 121 for converting a transmission light pulse signal 14 output from the optical waveguide 116 of the transmitting unit 110 into a semi-pointer balance integration optical signal 122, an optical divider 123 for partially transmitting and reflecting the semi-pointer balance integration optical signal 12, and a beam scanner 128 for pointer-scanning a portion (for example, 90% of the optical signal 122) of the divided integration optical signal on a space to be measured.

Also, the optical transceiving unit 120 further includes a reflection mirror for totally reflecting the other portion (for example, 10% of the optical signal 122) of the divided integration optical signal and a receiving-side collimator 134 for collecting a reception optical signal 133 and delivering the reception optical signal 133 to the receiving unit 140, the reception optical signal being obtained by transmitting an optical signal 132 through a beam scanner 128, and the optical signal 132 being obtained by reflecting from one point 131 of the object 130 a pointer beam 129 output by the beam scanner 128 to a space.

A portion 125 of the integration optical signal 122 totally reflected from the reflection minor 126 is partially reflected by the optical divider 123 again, and a portion (for example, 90% of 10% of the optical signal 122, that is, 9%) is delivered to the receiving unit 140 through the receiving-side collimator 134.

Here, the transmission optical signal delivered to the receiving unit 140 through the receiving-side collimator 134 is utilized as a transmission monitoring optical signal 127′ for monitoring an output power intensity and pulse timing of the transmission pointer beam 129.

In this case, the transmission monitoring optical signal 127, and the reception optical signal 135 which is returned from the object on the space are delivered with an interval, from the receiving-side collimator 134 to the receiving unit 140.

A balance integration degree, that is, a size and an angle of the transmission pointer beam 129 is determined by a combination of an optical system, which is included in the balance integration optical signal 122 from the transmitting unit 110, the transmitting-side collimator 121, the optical divider 123, and the beam scanner 128, and an optical distance of the beam.

A position of the optical divider 123 in a vertical direction of a progressing axis of the reception optical signal 133 between the beam scanner 128 and the receiving-side collimator 134 is determined by an inclined acceptance angle of the receiving unit determined by the optical system of the receiving unit 140 and the receiving-side collimator 134.

Accordingly, the optical divider 123 may be positioned out of an edge of a beam size of the reception optical signal 133 or positioned at any point within the beam size.

The receiving unit 140 includes WDM filters 145 and 146 for demultiplexing pulse signals having different wavelengths included in the transmission monitoring optical signal 127′ and reception optical signal 135 and detectors 141, 142, and 143 for receiving wavelength signals 17, 18, and 19 at wavelengths λ1, λ2, and λ3, which are branched from the WDM filters 145 and 146.

A three-wavelength signal included in the transmission monitoring optical signal 127′ is input to the receiving units 141, 142, and 143 for each wavelength, in addition to the output of the transmission pointer beam 129, to provide information about the transmission output power intensity and pulse timing. A three-wavelength reception signal included in the reception optical signal 135 is input after a round-trip time to the reflection point 131 to provide information about a distance and direction to the object and reflection signal intensities of respective wavelengths.

When a plurality of lidar sensors are distributed over a space where the measurable distances overlap with each other, there is high possibility to generate a virtual image or noise information due to interference between adjacent sensor signals. Thus, the lidar sensor apparatus according to the present invention provides means for reducing the error.

As a detailed configuration for this, the transmission optical pulse signal output from the transmitting unit 110 may include a first wavelength optical pulse signal having any wavelength and a second wavelength optical pulse signal with a predefined time interval from the first wavelength optical pulse signal. Here, the second wavelength optical pulse signal does not mean any one signal having a wavelength different from that of the first wavelength optical pulse signal, but means a set of optical pulse signals having wavelengths different from that of the first wavelength optical pulse signal.

Also, at least one of single-wavelength optical pulse signals having various wavelengths constituting the transmission optical pulse signal may be generated in a dual pulse form with a predefined time interval.

Referring to FIG. 3, the technical spirit of the present invention will be described in detail to remove interference and noise.

Graphs 301, 302, and 303 of FIG. 3 illustrate that a pulse signal 311 output from a λ1 wavelength light source of the three-wavelength image lidar transmitting unit and λ2 and λ3 wavelength pulse signals 312 and 313 are output as one transmission pulse group having time differences d1 and d2, respectively.

A time period T 310 represents a time interval from a time point t0 where the lidar sensor apparatus outputs a transmission pulse signal, to a time point t1 corresponding to a time as twice as a time taken by a light to reach a maximum target distance to be measured.

Graphs 304, 305, and 306 show time intervals and reception signals reflected and returned from objects positioned closer than the maximum target distance.

Referring to FIG. 3, normal three-wavelength reception pulse signals 321, 322, and 333 may show that the transmission pulse signals 311, 312 and 313 are reflected and received at a time interval M1 320, and the time differences between the λ1 wavelength pulse signals and the λ2 and λ3 wavelength pulse signals 312 and 313 are d1 and d2, respectively.

Also, unlike the λ1 and λ2 wavelength reception pulse signals 331 and 332 received at a time M2 330, it can be seen that the λ3 reception pulse signal is not within the time difference d2 with respect to the λ1 wavelength pulse 331. If the λ3 wavelength transmission pulse signal among the λ1, λ2, and λ3 wavelength transmission pulse signals 311, 312, and 313 is completely absorbed by an object or received by the receiver under a detectable intensity level.

Like this, generating the three-wavelength transmission pulse signals with the time differences d1 and d2 may have an effect of distributing the output power intensities of the transmission optical signals having different wavelengths, and also is utilized as mean for checking reliability of a reception signal detected by comparing intervals between pulse signals detected for each wavelength by the receiving unit of the lidar sensor apparatus as illustrated above, with the intervals of the transmission pulse signals to check whether the reception signal is received within a tolerable error range.

In addition, as additional means together with the time intervals d1 and d2 between the wavelength pulse signals 311, 312, and 313, it is possible to enhance reliability of measurement data using the transmission pulse signal generated in a dual pulse form having the time interval of t 353 on the basis of the single-wavelength signal, as shown in reference number 350.

That is, if the time interval between wavelength reception pulse signals is not within the tolerable error range with respect to the time intervals d1 and d2 between the transmission pulse signals, the received signal may be considered as an interference signal and noise generated by another lidar.

Also, in graph 306, when only a single-wavelength pulse, such as a signal 343, is received, it is possible to distinguish a case where the reception signal is due to noise from a case where two wavelength signals among the three-wavelength transmission pulse signals are absorbed by a target object, or reflected and received at a non-detectable intensity, by checking the time interval t 361 between the single-wavelength reception pulses in 360. As shown in FIG. 3, the time interval t of the single-wavelength dual pulse and the time interval d1 and d2 between wavelength pulse signals allow lidars to have different combination of time intervals, and thus provide means for remove the interference signal from another lidar or naturally occurring noise from a reception signal of a detector.

The three-wavelength image scanning lidar sensor apparatus according to an embodiment of the present invention may further include a processor (not shown) for processing the reception optical signal 135.

The processor calculates chromatic coordinate information about the reception optical signal, which varies depending on the reflection signal intensities of respective wavelengths measured by the receiving unit 140.

More specifically, the processor calculates ratios between the reflection signal intensities of respective wavelengths and uses the ratios as the chromatic coordinate information.

Furthermore, the processor compares the chromatic coordinate information with a material database classified into hierarchical classes according to the ratios between the reflection signal intensities of respective wavelengths to provide probabilistic information about materials that are matched to the chromatic coordinate information.

In addition, the processor forms a three-dimension image frame of the measurement space, using the chromatic coordinate information and three-dimension position coordinate information about measurement points, the three-dimension position coordinate being determined by the time taken by the reception optical signal to be reflected and returned from a measurement point of each of objects positioned on the measurement space.

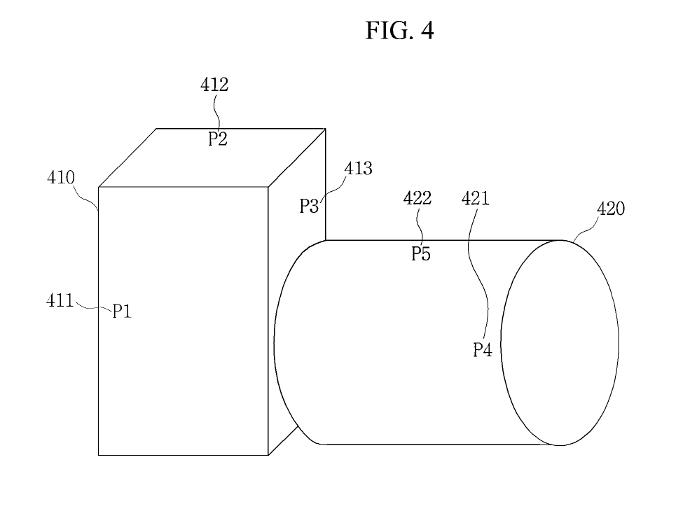

Hereinafter, a signal processing method performed by the processor will be described with reference to FIGS. 4 to 7.

FIG. 4 illustrates any measurement points P1 411, P2 412, and P3 413 distributed over a surface of an object 410 on the space and any measurement points P4 421 and P5 422 distributed over a surface of an object 420 on the space.

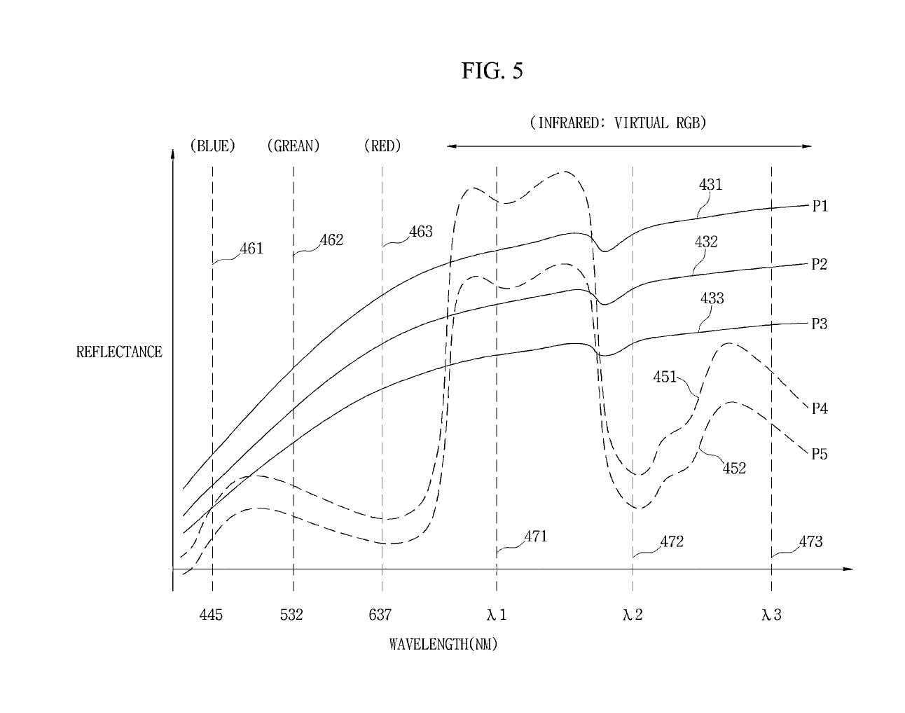

FIG. 5 illustrates reflectance according to the wavelength of the three-wavelength lidar light source at any measurement points P1 to P5 as shown in FIG. 4.

Referring to FIG. 5, reflectance graphs in the measurement points P1 to P3 on the object 410 formed of one material have similar tendencies, but show difference numerical values due to a state, slope, etc. of the surface of the object 410.

Likewise, reflectance graphs in the measurement points P4 and P5 on the object 420 formed of different materials have similar tendencies, but have different tendencies from the reflectance graphs in the measurement points P1, P2, and P3 on the object 410.

As wavelengths used in the three-wavelength image lidar sensor apparatus, wavelengths 461, 462, and 463 for blue, green, and red in the visible light region may be selected to implement a full-color image, and λ1, λ2, and λ3 wavelengths 471, 472, and 473 in the infrared ray region may be selected for eye safety.

As an example, the intensity of the reception signal measured from the λ1 wavelength signal in the infrared ray region is utilized as a value for blue color, the intensity of the reception signal measured from the λ2 wavelength signal in the infrared ray region is utilized as a value for green color, and the intensity of the reception signal measured from the λ3 wavelength signal in the infrared ray region is utilized as a value for red color.

A color image that is represented by the signals measured from the wavelengths in the infrared ray region may be represented differently from an actual color that is viewed by a human eye. However, the color image may be used as a chromatic coordinate for identification and tracking of an object when a signal processing is performed for automation, as well as allows a human eye to intuitively distinguish between objects when the sensor signals measured by the three-wavelength lidar sensor apparatus are directly represented through a color display.

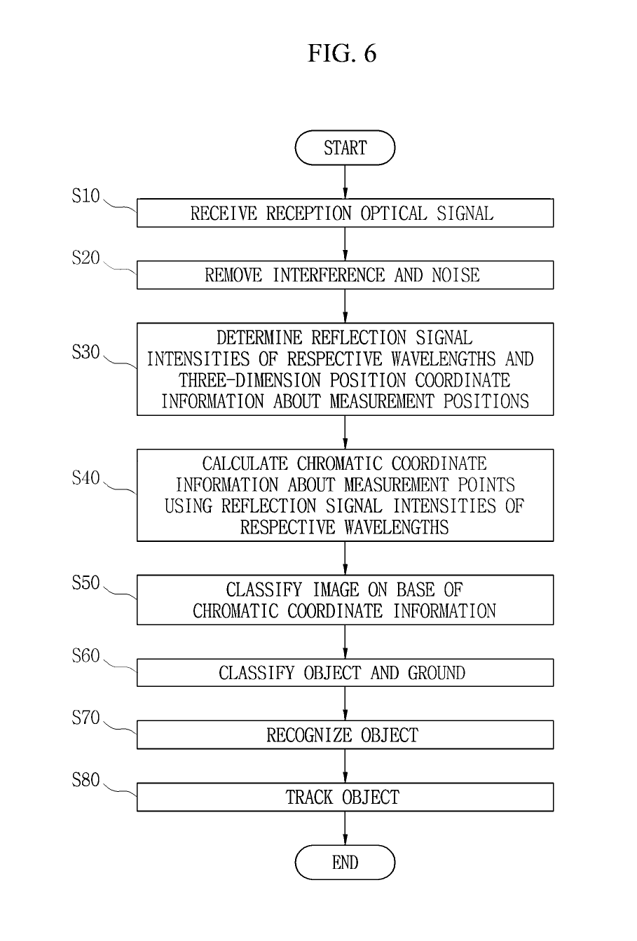

FIG. 6 is a flowchart showing a signal processing method utilizing a sensor signal measured according to another aspect of the present invention.

The signal processing method according to the present invention includes acquiring a three-wavelength signal reflected and received from any measurement point on a space to be measured in operation S10, checking time intervals between transmission/reception signals, as described in FIG. 3, to remove unnecessary interference or noise signals in operation S20, determining a wavelength reflectance and x, y, and z coordinates for each measurement point on the basis of filtered signals in operation S30, and determining ratios between reflectances in wavelengths λ1, λ2, and λ3 and the chromatic coordinate information indicating chromatic information fro each measurement point in operation S40.

In this way, the signal processing method according to the present invention may form the measurement space as a single three-dimension image frame through operations S10 to S40. As a result, the chromatic coordinate information and the three-dimension position coordinate information about each measurement point of the measurement space are generated as one set, and the information set is generated as chromatic 3D point cloud data.

Subsequently, a post-processing procedure, such as object detection and object tracking, is performed on the basis of the chromatic 3D point cloud data.

Specifically, classifying images on the basis of the chromatic coordinate information in operation S50, classifying a ground and measurement objects from the classified image information in operation S60, and identifying measurement objects in operation S70 are performed.

For example, if there are an object size and a measurable surface, a vertical component direction of the surface is determined, and a median value and an average value between reflectance coefficients and color information are determined from point information forming a measurement object.

Next, tracking the measurement object with the elapse of time from continuous three-dimension image frames having undergone signal processing procedures from S10 to S70 is performed in operations S80. In operations S80, a moving target may be classified and a moving speed of the target may be measured through position tracking of measurement objects, and the rotation of the object is also measured through tracking change in the size and surface vertical direction of the object.

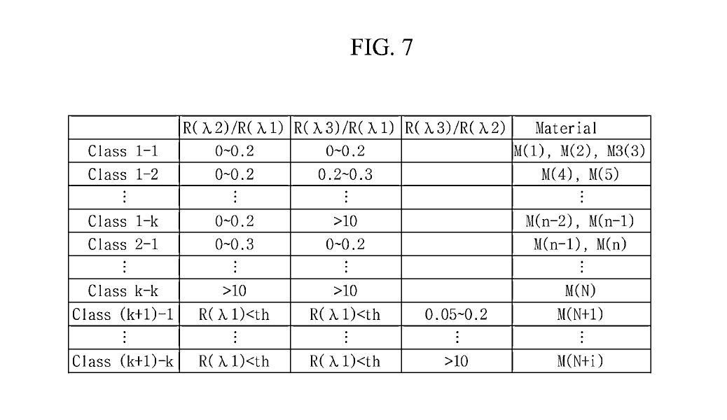

FIG. 7 shows a table, where the ratio of wavelength reflectance is classified into several classes (layers) in operation S40 of FIG. 6, and several materials are classified for each layer. Several materials may be for each layer. In this case, by prioritizing the materials according to distribution in the natural world, a possibility where a target object measured by the three-wavelength lidar sensor apparatus is formed of any material may be provided as probabilistic information.

A three-wavelength image flash lidar sensor apparatus according to another embodiment of the present invention will be described with reference to FIG. 2.

FIG. 2 is a block diagram showing a configuration of a three-wavelength image scanning lidar sensor apparatus according to another embodiment of the present invention.

Referring to FIG. 2, the three-wavelength image flash lidar sensor apparatus according to another embodiment of the present invention includes a transmitting unit 210 and a receiving unit 240.

The transmitting unit 210 includes three-wavelength light sources 211, 212, and 213 and WDM filters 214 and 215 for multiplexedly integrating optical pulse signals 21, 22, and 23 having wavelengths of λ1, λ2, and λ3 output therefrom into a single optical waveguide 216. These configurations are the same as the transmitter of FIG. 1. Thus, detailed description thereof will be omitted.

An optical divider 221 branches a portion (for example, 10%) of the intensity of the three-wavelength transmission optical signal 217 and monitors the branched portion through the optical detector 223 to provide the intensity of the output optical signals 224 and 226 and pulse timing information.

An optical signal 224 of the other portion (for example, 90%) of the three-wavelength transmission optical signal 217 is converted into a three-wavelength optical transmission signal 226 having a relatively wide divergence angle and output to the measurement space by a beam extender 225.

The receiving unit 240 includes a collimator 232 for receiving and collecting a three-wavelength optical signal 231 reflected from objects, WDM filters 245 and 246 for demultiplexing a reception signal 233 for each wavelength, and detectors 241, 242, and 243 for receiving the wavelength optical signals 27, 28, and 29.

The signal processing method in the lidar sensor apparatus according to the present invention can also be implemented as computer readable codes on a computer readable recording medium. The computer readable recording medium includes all kinds of recording medium for storing data that can be thereafter read by a computer system. Examples of the computer readable recording medium may include a read only memory (ROM), a random access memory (RAM), a magnetic disk, a flash memory, optical data storage device, etc. Also, the computer readable recording medium can also be distributed throughout a computer system connected over a computer communication network so that the computer readable codes may be stored and executed in a distributed fashion.

In a case where the multi-wavelength lidar sensor apparatus according to the present invention is utilized as described above, it is possible to accurately and quickly identify and track the object by adding a function of measuring unique material characteristics, such as a color and reflectance of the object, to the three-dimension image lidar sensor for measuring a position and speed of the object.

In addition, using a method of generating and receiving the multi-wavelength transmission/reception pulse signals according to the present invention, it is possible to remove interference and naturally occurring noise between adjacent lidar sensor signals when a plurality of lidar sensors are distributed on a space where measurable distances partially overlap with each other.

It will be understood by those skilled in the art that various changes in form and details may be made therein without departing from the spirit and scope of the invention as defined by the appended claims. The above embodiments are accordingly to be regarded as illustrative rather than restrictive. Therefore, the scope of the invention is defined not by the detailed description of the invention but by the appended claims, and a variety of embodiments within the scope will be construed as being included in the present invention.

What is claimed is:

1. A multi-wavelength image lidar sensor apparatus comprising:
a transmitting unit configured to output a multi-wavelength optical pulse signal;
an optical transceiving unit configured to convert the multi-wavelength optical pulse signal into a transmission optical signal, output the transmission optical signal to a space, and transmit a reception optical signal generated by collecting signals, the signals being obtained by reflecting the transmission optical signal on the object of the space;
a receiving unit configured to measure reflection signal intensities of respective wavelengths in the reception optical signal; and
a processor configured to calculate chromatic coordinate information about the reception optical signal, the chromatic coordinate information varying depending on the reflection signal intensities of respective wavelengths.

2. The multi-wavelength image lidar sensor apparatus of claim 1, wherein the processor is configured to calculate ratios between the reflection signal intensities of respective wavelengths and use the ratios as chromatic coordinate information.

3. The multi-wavelength image lidar sensor apparatus of claim 1, wherein the processor is configured to compare the chromatic coordinate information with a material database classified into hierarchical classes according to the ratios between the reflection signal intensities of respective wavelengths to provide probabilistic information about materials matched to the chromatic coordinate information.

4. The multi-wavelength image lidar sensor apparatus of claim 1, wherein the processor is configured to form a three-dimension image frame for the measurement space using the chromatic coordinate information and three-dimension position coordinate information about each measurement position, the three-dimension position coordinate information being determined according to a time taken by the reception optical signal to be reflected and returned from each measurement point of objects disposed on a measurement space.

5. The multi-wavelength image lidar sensor apparatus of claim 1, wherein the transmission optical signal comprises a first wavelength optical pulse signal having any wavelength, a second wavelength optical pulse signal with a predefined time interval from the first wavelength optical pulse signal, and a third wavelength optical signal with a predefined time interval from the second wavelength optical pulse signal.

6. The multi-wavelength image lidar sensor apparatus of claim 1, wherein optical pulse signals having several wavelengths constituting the transmission optical signal comprises at least one single-wavelength optical pulse signal, the single-wavelength optical pulse signal being generated in a dual-pulse form with a predefined time interval.

7. The multi-wavelength image lidar sensor apparatus of claim 5, wherein the receiving unit compares a time interval of optical pulse signals detected for each wavelength in the reception optical signal with a time interval predefined in the transmission optical signal and checks whether the reception optical signal is received within a tolerable error range to evaluate reliability of the reception optical signal.

8. The multi-wavelength image lidar sensor apparatus of claim 6, wherein the receiving unit checks whether any one single-wavelength optical pulse signal in the reception optical signal has a dual pulse form with a predefined time interval to evaluate reliability of the reception optical signal.

9. The multi-wavelength image lidar sensor apparatus of claim 1, wherein the transmitting unit comprises light sources configured to output optical pulse signals having a certain time interval and different wavelengths and filters configured to multiplexedly integrate the optical pulse signals into a single optical waveguide and output the optical pulse signals as a multi-wavelength transmission optical pulse signal.

10. The multi-wavelength image lidar sensor apparatus of claim 1, wherein the optical transceiving unit comprises:
a transmitting-side collimator configured to convert a multi-wavelength transmission optical pulse signal into a semi-pointer balance integration optical signal;
an optical divider configured to transmit a portion of the semi-pointer balance integration optical signal and reflect another portion thereof;
a beam scanner configured to pointer-scan a portion of an optical signal divided by the optical divider, on a space;
a reflection minor configured to totally reflect another portion of the optical signal divided by the optical divider; and
a receiving-side collimator configured to collect signals obtained by reflecting an optical signal on one point of an object, the optical signal being pointer-scanned on a space, and deliver the signals to the receiving unit.

11. A method of processing a reception optical signal obtained by reflecting a multi-wavelength transmission optical signal on any material of a space, the multi-wavelength transmission optical signal being transmitted from a multi-wavelength image lidar sensor apparatus, the method comprises:
(a) receiving the reception optical signal reflected and returned from any measurement point of any material;
(b) determining reflection signal intensities of respective wavelengths included in the reception optical signal and three-dimension position coordinate information about any measurement point;
(c) calculating chromatic coordinate information about any measurement point using the reflection signal intensities of the respective wavelengths; and
(d) forming a three-dimension image frame for the measurement space using the three dimension position coordinate information about any measurement point and the chromatic coordinate information.

12. The method of claim 11, wherein the calculating of chromatic coordinate information comprises calculating ratios between the reflection signal intensities of respective wavelengths.

13. The method of claim 11, wherein the transmission optical signal comprises a first wavelength optical pulse signal having any wavelength, a second wavelength optical pulse signal with a predefined time interval from the first wavelength optical pulse signal, and a third wavelength optical signal with a predefined time interval from the second wavelength optical pulse signal.

14. The method of claim 11, wherein at least one of single-wavelength optical pulse signals having several wavelengths constituting the transmission optical signal is generated in a dual-pulse form with a predefined time interval.

15. The method of claim 13, further comprising removing interference and noise from the reception optical signal between (a) step and (b) step,
wherein the removing of interference and noise comprises comparing a time interval of optical pulse signals detected for each wavelength in the reception optical signal with a time interval predefined in the transmission optical signal and checking whether the reception optical signal is received within a tolerable error range.

16. The method of claim 14, further comprising removing interference and noise from the reception optical signal between (a) step and (b) step,
wherein the removing of interference and noise comprises checking whether any one single-wavelength optical pulse signal in the reception optical signal has a dual pulse form with a predefined time interval.

17. The method of claim 11, wherein the forming of a three-dimension image frame comprises comparing the chromatic coordinate information with a material database classified into hierarchical classes according to the ratios between the reflection signal intensities of respective wavelengths to provide probabilistic information about materials matched to the chromatic coordinate information.

18. The method of claim 11, wherein the forming of a three-dimension image frame comprises comparing comprises:
classifying image information from the three-dimension image frame using the three-dimension position coordinate information about each measurement point;
classifying a ground and measurement objects from the classified image information; and
identifying the measurement objects.

19. The method of claim 11, wherein the forming of a three-dimension image frame comprises displaying the chromatic coordinate information measured on the basis of a wavelength in an infrared ray region, with three primary colors R, G, and B in a visible light region, to provide visual information.
